(19) United States
(12) Patent Application Publication
(10) Pub. No.: US 2011/0071686 A1
(43) Pub. Date: Mar. 24, 2011

(54) Coalescence of Compartmental Entertainment Units for Intellectual Property Screening

(75) Inventor: Michael Saigh, St. Louis, MO (US)

(73) Assignee: Microplex Cinemas, LLC, Las Cruces, NM (US)

(21) Appl. No.: 12/957,532

(22) Filed: Dec. 1, 2010

Related U.S. Application Data
(63) Continuation of application No. 11/805,452, filed on May 23, 2007, now abandoned.

(51) Int. Cl. G06Q 30/00; G05B 15/02

(52) U.S. Cl. 700/275; 705/26.25

(57) ABSTRACT

The present invention is directed towards, in one embodiment, a system, process or method for controlling, operating, displaying, generating, rendering or otherwise managing the IP content within a retail structural facility. In a preferred embodiment, the present invention comprises a retail structural facility having a computer controlled system adapted for consumer browsing, retrieval, access, consumption, control of, and interaction with, all forms of available intellectual property content within one or more screening chambers within the retail structural facility. The computer controlled system may include at least one computer system, or may include a plurality of computer systems in electronic communication with other on-site computer systems, or in electronic communication with off-site computer systems, mobile devices, and the Internet. The present invention is adapted to allow consumers to consumer intellectual property content upon demand on a predetermined audio/video system within the facility, within a time schedule set by the consumer. In another embodiment, the present invention allows the adjustment the screening chambers to maximize viewing quality and sensory perception.

### CLAIM OF PRIORITY

The present invention claims priority based upon U.S. Patent Application No. 60/802,601, filed May 23, 2006 to Saigh et al. and titled “Coalescence Of Compartmental Entertainment Units For Intellectual Property Screening”, which is hereby incorporated by reference.

### FIELD OF INVENTION

The present invention relates generally to the management, control and operation of an entertainment retail structural facility having a plurality of screening chambers adjustable to accommodate a wide range of intellectual property content (“IP content”) offerings. In this context, “IP content” includes (but is not limited to), movies, television broadcasts, videos, music, video games, e-books, educational material, sports broadcasts, pay-for-view events and live concert broadcasts. In addition, the present invention allows management to adjust the screening compartments in order to maximize IP content viewing quality.

### BACKGROUND OF THE INVENTION

Current movie theaters usually incorporate multiple, separate theater chambers having finite seating capacity. Such theater chambers are typically separately operated through an operator in a rear theater chamber booth. The public becomes aware of the available movie listing by advertisements in magazines, television or radio, and has the ability to view the available movie listings through the Internet or newspaper. In addition, current multi-screen or multiplex theaters have fixed seating that is seldom at capacity and most often underutilized. Another drawback of the present state of the art is that the movies listings available to a consumer are restricted and scheduled by management, and most usually are formulated due to a contract with movie studios and movie distributors. Furthermore, when a blockbuster movie is offered, such screenings utilize multiple screens simultaneously within the complex, and are often sold out (especially during the opening weekend of the movie). These theatres are not adapted to provide other types of IP offerings, such as offering virtual or on-line gaming systems.

Consumers now have the choice to view movies or play gaming systems at home. For example, video may be downloaded or streamed from a central database and disseminated to a home viewed by a home devices. This technology is described, for example, in U.S. Pat. No. 5,734,823 titled “System and Apparatus for Electronic Communication and Storage of Information”. This patent discusses a video on demand network that concurrently protects copyright and electronically transfers various intellectual property to various electronic devices, including, but not limited to, set-top boxes, computers or handheld mobile devices. “IP”, as used in this disclosure, is defined to include any form of intellectual property, including but not limited to, movies, holographic movies, Omnimax, electronic games, live broadcasts or controlled saved broadcasts of live concerts or lectures, sporting events or any other type of event. IP also definitionally includes music, e-books, software, audio/video conferencing and all other intellectual property including corporate information and all other information regarding any and all IP sourcing. In addition, this patent incorporates copyright protection algorithms as well as a description of time base rental, where the selected IP automatically self-destructs after a prescribed period of time.

U.S. Pat. No. 5,734,823 is deficient, however. While U.S. Pat. No. 5,734,823 describes a customization of IP offerings available to the consumer home and retail environment, it does not describe viewing or interaction of the Intellectual property, including a consumer's communication, contact, interface, dealing and relations with the IP. In addition, this patent does not describe the setting of the IP. Moreover, this patent fails to disclose control or manipulation of the IP outside of the home environment (such as at the retail environment). In addition, this patent fails to recognize the control or manipulation of IP through mobile devices within a retail environment. The current invention describes only the access and interaction of all forms of IP in a retail complex or structural facility. In addition, the current invention only pertains to the access, retrieval and interaction of any form of IP confined in a managed retail environment. In addition, the IP is disseminated and accessed solely within the retail environment and not outside the retail environment.

### SUMMARY OF THE INVENTION

The following summary of the invention is provided to facilitate an understanding of some of the innovative features unique to the present invention, and is not intended to be a full description of variations that may be apparent to those of skill in the art. A full appreciation of the various aspects of the invention can be gained from the entire specification, claims, drawings, and abstract taken as a whole.

The present invention comprises a retail structural facility having a computer controlled system adapted for consumer browsing, retrieval, access, consumption, control of, and interaction with, all forms of available IP content within one or more screening chambers within the retail structural facility. The computer controlled system may include at least one computer system, or may include a plurality of computer systems in electronic communication with other on-site computer systems, one or more electronically interactive customer kiosks, or in electronic communication with off-site computer systems, electronic mobile devices, and the Internet. The present invention is adapted to disburse IP to consumers in a private and/or public manner upon demand by a consumer, the computer controlled system further adapted to disburse intellectual property content to the consumer on a predetermined, adjustable screening chamber having an audio/video system within the facility, within a time schedule set to the consumer.

The term “consumption”, as it applies to this disclosure for example, means that the customer has finished viewing, playing, studying, analyzing, hearing, contemplating or absorbing the IP content. Upon consumer consumption, the present invention may provide, control or otherwise manage the IP content to the consumer in the retail facility by ceasing streaming of the IP content through a predetermined cut-off time of the viewed IP content. In another embodiment, the present invention may provide, control or otherwise manage the IP content to the consumer in the retail facility by ceasing streaming of the IP at the end of the source of IP (e.g., when the movie ends, when the selected songs end, or when the digital content is finished). In yet another embodiment, the present invention may provide, control or otherwise manage the IP content to the consumer in the retail facility by allowing the consumer to continue to interact with the selected IP content on a time rental basis. As applied to this disclosure, the term “screening” refers to the retail complex's interactive retail complex equipped with the ability to access (and interact with) various types of IP content. Thus, for example, a “screening” of musical content may only require the invention's ability to access and provide audio streaming to the representative audio/visual system in a screening chamber (e.g., no video is required). As another example, a “screening” of a video game may require the present invention's ability to access and provide audio, video and full wide area network access from the Internet to the audio/video system in the screening chamber. A full description of the “screening” facility and screening chambers is disclosed elsewhere in this disclosure.

The present invention centralizes the convenient delivery of IP content to consumers within a retail environment within a structural facility. Each facility is adapted to host all forms of IP content for on-site consumption by consumers.

The novel features of the present invention will become apparent to those of skill in the art upon examination of the following detailed description of the preferred embodiment or can be learned by practice of the present invention. It should be understood, however, that the detailed description of the preferred embodiment and the specific examples presented, while indicating certain embodiments of the present invention, are provided for illustration purposes only because various changes and modifications within the spirit and scope of the invention will become apparent to those of skill in the art from the detailed description, drawings and claims that follow.

### BRIEF DESCRIPTION OF THE DRAWINGS

The accompanying figures further illustrate the present invention and, together with the detailed description of the preferred embodiment, assists to explain the general principles according to the present invention.

FIG. 1 is a graphical representation of the computer control system disclosed in the present invention;

FIG. 2 is a graphical representation of another embodiment of the of the computer control system disclosed in the present invention;

FIG. 3 is an exemplary top plan view of a representative facility housing a process for receiving, managing and disbursing intellectual property content in accordance with the present invention;

FIG. 4 is an exemplary graphical representation of the movable or otherwise adjustable walls disclosed in the present invention;

FIG. 5 is a top plan view of a representative optical correction bracket as may be used in one or more embodiments of the present invention;

FIG. 6 is a side plan view of the optical correction bracket shown in FIG. 5;

FIG. 7 is a top plan view of another representative optical correction bracket as may be used in one or more embodiments of the present invention;

FIG. 8 is a side perspective view of the bracket illustrated in FIGS. 5 and 6 retaining a projector P (the projector P represented by dashed lines); and

FIG. 9 is a graphical representation of a video system which may be formed upon the facility exterior according to the present invention.

Additional aspects of the present invention will become evident upon reviewing the non-limiting embodiments described in the specification and the claims taken in conjunction with the accompanying figures, wherein like reference numerals denote like elements.

### DETAILED DESCRIPTION OF THE PREFERRED EMBODIMENT

The present invention is directed towards, in one embodiment, a system, process or method for controlling, operating, displaying, generating, rendering or otherwise managing the IP content within a retail structural facility. In a preferred embodiment, a representative structural facility is a structural means for accommodating a IP content retrieval system, and for accommodating at least one of the following: a theater, an arcade, a bowling center, a hall area, and a pod, or a food and concession area. In one instance, the facility includes at least one computer controlled system adapted for consumer browsing (or, partial consumption) of IP content, retrieval of IP content, access to IP content, consumption of IP and interaction with IP within the retail structural facility. The present invention allows for consumers to consume IP content directly at the retail structural facility having a computer controlled system adapted for consumer browsing, retrieval, access, consumption and interaction with all forms of available IP content within the retail structural facility. The computer controlled system may also include a plurality of computer systems in electronic communication with other on-site computer systems, or in electronic communication with off-site computer systems, mobile devices, and/or the Internet. The available IP content may be stored on-site within the computer system, or, alternatively, may be obtained electronically from an off-site source or computer through a computer network such as the Internet.

The present invention's computer system may also be adapted to allow each consumer of IP to communicate electronically amongst themselves (e.g., in a first screening chamber) or with other consumers (on-site or remotely located in at least a second remotely located screening chamber) through a centralized communication linking audio/video network which may be connected to a global computer network such as the Internet, either through a secure network or non-secure network. As used herein, the term “network” refers to any electronic interconnection between two or more electronic devices over which data is transferred, including, but not limited to, the Internet, an intranet, a land line or traditional telephone network, a cellular or wireless mobile network, a wireless microwave network, television or radio wave transmissions, a cable network, a wireless connection (for example, infrared or microwave connections), satellite, a localized land network system, induction connection using electric lines, a wireless network using lasers as the transmitting medium, any combination of any of the preceding or any other system for the transmission of data between two or more units. A “secure network” is a network employing security measures against unauthorized access to data being transmitted via the network or data stored within a memory storage area of a device connected to the secure network. And, the term “facility” may refer to a multi-story building, or a single level building, or a custom designed building that is location specific as to marketing needs and site ramifications. The present invention also allows for integration and/or communication with other retail complexes (such as, for example, a bowling center, an arcade center, a bookstore or a cafe.

The present invention may be embodied as a system, process or method. Other variations and modifications of the present invention will be apparent to those of ordinary skill in the art, and is not limited except by the appended claims. The particular designs and configurations discussed herein can be varied, and are cited to illustrate particular embodiments of the present invention. It is contemplated that the use of the present invention can involve components having different characteristics as long as the principles disclosed herein are followed.

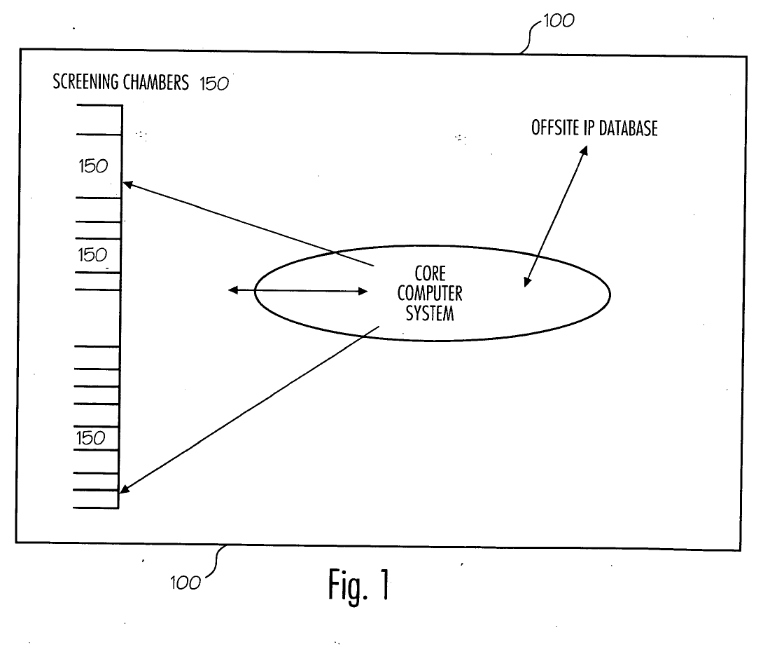

FIG. 1 illustrates a graphical view of one exemplary embodiment of representative structural facility which can house a system, process or method for controlling, operating or otherwise managing a retail structural facility having a computer controlled system adapted for consumer browsing of IP content, retrieval of IP content, access to IP content, consumption of IP content and interaction with IP content within the retail structural facility. As seen in FIG. 1, a representative structural facility 100 may include one or more theatres 110, one or more arcades 120, one or more bowling centers 130, one or more hall areas 140, one or more pods or screening chambers 150 for individual or small group IP screenings, and at least one food and concession provider 160. In one embodiment, each of these industries may be represented by different management and different computer systems. Collectively, any one of these areas may be referred to as a “screening chamber”, whether individually or in any combination.

A computer system (not shown, but hereafter referred to as the Comprehensive Order Response Enterprise system, or CORE computer system) may be employed within the facility 100 and is adapted to access, control and disburse stored IP content to allow for consumer browsing, retrieval, access, consumption, control of, and interaction with the IP content within the retail structural facility. The CORE computer controlled system may include at least one computer system, or may include a plurality of computer systems in electronic communication with other on-site computer systems, or in electronic communication with off-site computer systems, mobile devices, and the Internet. The present invention is adapted to allow consumers private and/or public access to partially or fully consume IP content upon command on a predetermined video screen within the facility, within a time schedule set to the consumer. The CORE computer system is also adapted to facilitate communication amongst the various computer systems within the facility, or amongst management and customers.

Facility complex 100 processes orders received from IP order placement stations within a screening chamber (e.g., pod 150). In addition, IP content may be ordered in advance and received by facility complex 100 via telephone, a computer network such as the Internet, cellular phone, microwave communications, radio frequency, satellite communications, wireless personal digital assistants (PDAs), facsimile transmission or other order communication means. In addition, the customer may place IP content order orders using radio “bluetooth”, infrared, microwave, RF, satellite or other mobile wireless systems. When IP content is ordered in advance as further discussed below, the CORE computer system is adapted to receive the order, process the order, and digitally store the ordered IP on a server awaiting the customer's arrival at the retail facility. Those of skill in the art will now realize that any number of communication protocols may be employed to realize the advance ordering processing of the present invention, including by voice transmission, by voice synthesizer transmission, by audio transmission, by audio-visual transmission, by radio frequency transmission, by electronic signal transmission, by a touch screen; including by any type of wireless protocol comprising cellular, microwave, IEEE 802.11x, Bluetooth, satellite; and including by wirelan protocol comprising a telephone, a handheld devices, an onsite or offsite communication device, a point device, a touch device, a personal computer or any combination thereof.

The CORE system may be connected to other computer systems locally or remotely over a network. The network may be a public network and assumed to be insecure and open to eavesdroppers. In the illustrated implementation, the network may be embodied as the Internet and is preferably a secure network. In this context, the computers may or may not be connected to the Internet at all times. Specific information related to the protocols, standards, and application software utilized in connection with the Internet may not be discussed herein.

Those of skill in the art will realize that the CORE system of the present invention (and any element which communicates with such system) may be described herein in terms of functional block components, and various processing steps. It should be appreciated that such functional blocks may also be realized by any number of hardware and/or software components configured to perform the specified functions or steps. For example, the present invention may employ various computer systems, including memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, XML, COBOL, assembler, PERL, or the like, with the various algorithms being implemented with any combination of data structures, objects, processes, routines or other programming elements. Further, it should be noted that the present invention may employ any number of conventional techniques for data transmission, signaling, data processing, network control, and the like.

In a preferred embodiment of the present invention, each facility 100 may include one or more consumer screening chambers (e.g., chambers or pods 150) having at least one projector, monitor, television, flat screen device, video system or projection screen therein, at least one customer kiosk therein and a sound system, thereby defining an audio/video system. Of course, it would be desirable for the video components to provide a high definition or holographic view of the IP content, and for the audio system to provide the latest audio technology (such as surround sound). In this embodiment, each audio/video system electronically communicates with the CORE computer system and each corresponding customer kiosk to provide IP content to the consumer upon command. Ina preferred embodiment, any component within the audio/video system may communicate with the CORE computer system via wireless technology, wired technology, or any combination thereof. In one embodiment, a preferred video system may including a holographic system, a three-dimensional system, a wireless video screen formed from nanotechnology circuitry (such and nanotubes) or even wearable personal glass frames having a video system built therein, all in electronic communication with the CORE computer system.

In operation, when a consumer arrives at the facility 100, the consumer will be directed to a screening chamber. Those of skill in the art will realize a chamber may be a small room, a medium size room, or a large room, in either a fixed size or with varying seating capacity, so that preferably, the walls defining each screening chamber are adjustable to accommodate the number of persons within each screening chamber. Those of skill in the art will also come to realize that each screening chamber may directly adjoin one or more consumer chambers, with each chamber being preferably sound-proofed so that sound in one consumer chamber does not to disturb other consumer chambers. The facility 100 could incorporate an unlimited number of screening chambers, with each chamber being adjustable in size to accommodate any number of people in the chamber.

Optionally, the slope of the aisles within a screening chamber could be altered by any mechanical, electrical or other means when combining viewing chambers. For example, if a screening chamber is to the rear of another viewing chamber and combined, the slope and position of the seats could be mechanically controlled by the CORE computer system to optimize the viewing angle slope of the screening chamber. This could be accomplished by mounting the theater seats on a computer controlled platform that lifts and conforms to the slope of the front theater when being combined. In this way, two theater auditoriums or more could expand to conform to a larger viewing audience and still maintain the same viewing quality for every seat. The present invention allows any combination of theater chambers no matter where positioned (front, left, right rear or multiple) to be combined if the need arises. In addition, the present invention allows any screen size, walls, lighting, sound systems to be altered in any combination on order to create a continuous, functional viewing theater auditorium.

In exemplary operation, the CORE computer system is adapted to receive a consumer's order of IP content from within the screening chamber, process the IP content request, retrieve the IP content and provide the IP content to the consumer in the screening chamber via the corresponding monitor and audio system within the facility 100. The CORE computer system is also adapted to self-destruct or otherwise, disable, the IP content upon consumption. In this regard, the CORE computer system controls the full access and dissemination of the IP content within the facility.

Concurrently, the CORE computer system is adapted to monitor consumer commands and process such commands. Thus, for example, the CORE computer system is adapted to receive a consumer command (such as, for example, a “Pause IP” command) and process the commend (i.e., pause the IP content being displayed on the corresponding monitor and the corresponding audio on the audio system). The CORE computer system is also adapted to process consumer requests for ordering of food and/or beverages which may be offered by the facility. The core computer system may further be adapted to deliver ordered food and/or beverages to the consumer's location by a transportation means, such as for example, a conveyor system or delivery robots in electronic communication with the core computer system. This “like home” availability will allow customers the full availability of the movie or video game without missing a scene.

Preferably, the present invention also includes the introduction of a verification system (or, IP point of sale “IP POS”, as seen in FIG. 1) in communication with the core computer system. In this embodiment, the verification system is preferably adapted to authenticate identification of the customer who is purchasing the intellectual property content, verify the customer's ability to purchase the ordered intellectual property content, and if authentication and identification is confirmed, communicate to the core computer system to deliver the ordered intellectual property content to the customer at a predefined screening chamber.

The CORE computer system may be centrally located in the facility 100 in a control station room adjoining the screen chambers. In one embodiment, the projection system may also be centrally located in the facility 100 adjacent to the CORE computer system. While normally the CORE computer system is placed in a restricted area within the facility, it may optionally be connected to one or more customer CORE computer systems (hereafter, “CCORE computer systems”) which are available to customers within the facility. In this embodiment, a customer may insert their own IP content (such as, for example, a video game or DVD movie) into a CCORE computer system. Thereafter, the CORE computer system is adapted to retrieve the customer's IP content, ask the customer which screening chamber is desired, and then electronically transmit the customer's IP content to the desired screening chamber for consumption.

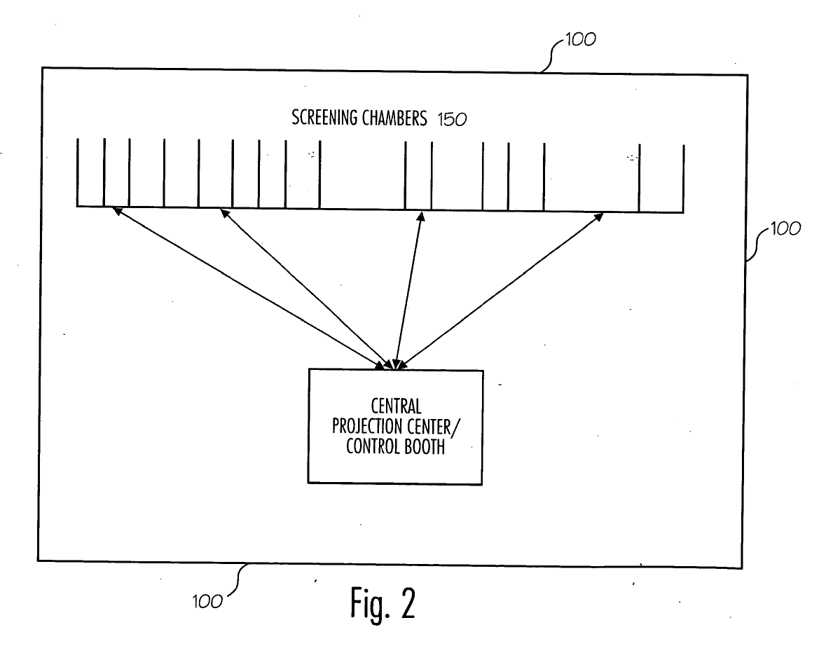

Additionally, as seen in FIG. 2, in those embodiments that utilize a projector to disburse IP content to a projection screen, a centralized projection center may be centrally located in the facility 100 in a centralized projection control room adjoining the screen chambers. In this regard, a centralized projection system can concurrently disburse IP content to any one of the predetermined screening chambers 150. Should any problems arise with any of the projectors, an operator can quickly fix such problems because all of the projection systems are adjacent to one another.

In still another embodiment of the present invention, the CORE computer system may be adapted to provide a customer with a display of IP content which, unknown to the customer, may be available at a different IP retail facility. In this embodiment, the CORE computer system is adapted to allow the customer to browse and choose the IP content they would like to access, retrieve, view and or interact with. If the IP content desired by the consumer is not available on the CORE computer system within the facility 100, the CORE computer system is adapted to electronically retrieve and store the desired IP content from a remotely located CORE computer system at another facility.

In yet another embodiment of the present invention, the CORE computer system may be programmed to accept customer IP content from a consumer for display in a screening chamber. This occurs, for example, when a consumer already owns a movie on DVD, but desires to view the DVD on a high quality large monitor or projection screen having a state-of-the-art audio system. This could also occur, for example, when a customer electronically transmits their own IP content to the CORE computer system over a network (such as the Internet) for later viewing in a screening chamber. The reference to electronically transfer is defined as having the CORE computer system accept, receive, secure, identify and store the IP content on any database accessible to the CORE computer system. When a customer electronically transfers their IP content to the CORE computer system, the CORE computer system may be adapted to assign a prepaid identification number to the customer, assign a RFID code or assign some other personal identification protocols which will allow the CORE computer system to display the IP content to a screening chamber upon proper verification by the customer. In one embodiment, such an identification verification generated by the CORE computer system will account and track the number of viewers interfacing or viewing the IP content, tabulate the usage of the IP content, will track the screening costs, and ultimately, assess charges to the customer. In one embodiment, a flat billing rate may be used, and in another embodiment, the CORE computer system may apply data metering techniques, time stamped techniques, or may track usage by the number of times the IP content is used by a customer. The CORE computer system may be programmed to directly accept payment from the consumer at the IP POS (as seen in FIG. 1) for the time to rent screening time in the screening chamber (as opposed to accepting payment through some other means, such as through a facility employee. The CORE computer system may be programmed to generate charges based on customer usage time, interaction capability and number of people accessing the screen content, or any combination of the foregoing.

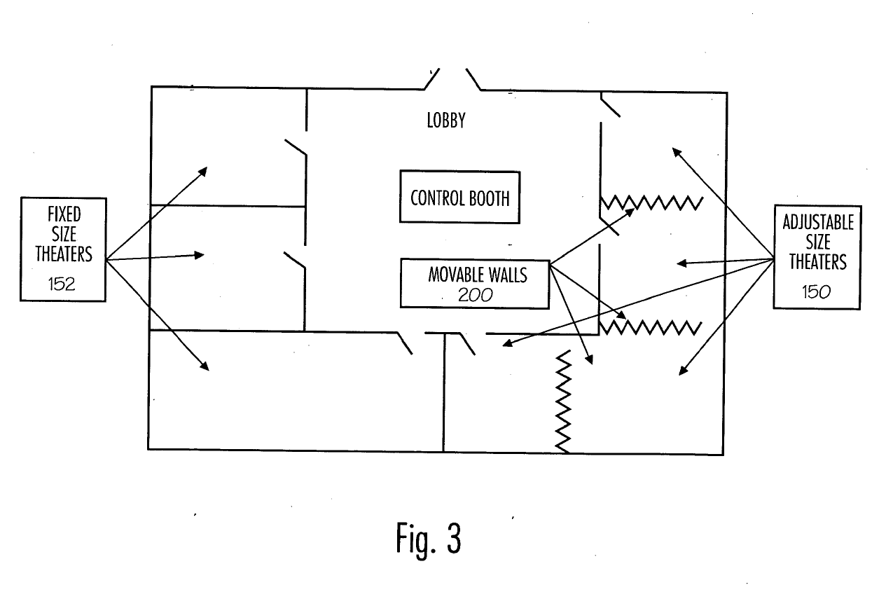

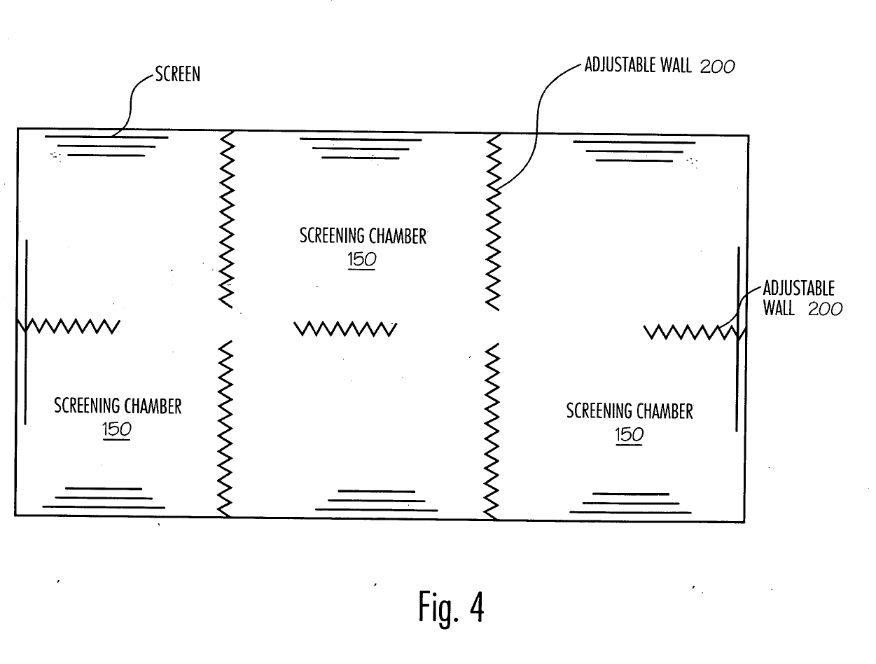

In another embodiment, the CORE computer system may be adapted to optimize seating and IP availability within the facility 100 based upon the number of requests for a particular IP content. Thus, for example, as seen in FIGS. 3 and 4, each screening chamber 150 may be defined by a plurality of wall structures 200 in electromechanical communication with the core computer system, so that the core computer system may electromechanically control each wall structure for movement so that the size of each screening chamber is adjustable (or, optimized) to accommodate the number of customers within each screening chamber. Moreover, each screening chamber 150 may include at least one seat and aisle structure in electromechanical communication with core computer system, so that the core computer system may electromechanically control each seat and aisle structure to optimize the viewing angle slope of each screening chamber. This may be a useful feature for high demand IP content available for viewing at a theatre 110. Thus, the present invention contemplates the use of both fixed size screening chambers 152 and adjustable size screening chambers 150.

In another preferred embodiment of the present invention, each screening chamber 150, 152 within the facility 100 is adapted to be moved, rotated or transfixed, adjusted, or maneuvered to flexibly accommodate the number of screen viewers. Thus, for example, the screening chamber's walls, seats, video screens, sound system, and/or the lighting arrangement may be manipulated by the CORE computer system to maximize the number of screen viewers or parties viewing or interacting with the IP content. In other words, screen size, seating arrangements, seating capacity, placement, and position will be mobilized and customized in order to maximize collective capacity.

The present invention also allows customers to choose IP content to view the IP content on a screen that maximizes viewing quality. Many homes are not equipped with surround sound and high definition screen clarity. Optimized viewing screens as contemplated by the present invention provide the viewer not only customized IP content, but an ability to interact with electronic games or view movies or other IP content. The present invention also allows management of the facility to maximize the utilization of space needed for such IP screening. In addition, an exemplary seating system may have built-in speaker systems, and may further include food holding trays, game controllers for any type of electronic games and other apparatuses' to enhance the view quality and interactive comprehension of IP content.

In addition, in another embodiment of the current invention, the customized schedule of the present invention may allow additional patrons (as walk-in traffic) to share the screening chamber. The CORE computer system may be adapted to control electronic billboards within the facility (or on the facility exterior) to display all IP content currently being screening. In this case, the renter of the IP screening facility will allow such walk-in traffic in order to lower his screening room cost.

Those of skill in the art will no come to realize that not only movies and broadcasts are available for IP screening in each screening chamber. Alternatively, the CORE computer system is adapted to provide electronic video game IP content in one or more screening chambers. In this embodiment, the CORE computer system is adapted to communicate with any electronic video game platform (including but not limited to Xbox, Xbox 360, Playstation 2, Nintendo, Nintendo Wii and like platforms) to provide the gaming experience to each customer within a screening chamber. The CORE computer system is further adapted to allow communication not only between gaming platforms and screening chambers, but is also adapted to communicate with remotely located IP content on the Internet, thereby allowing garners the ability to compete with other garners outside the complex and keep a accumulative score with all garners inside or outside the retail complex. In addition, another embodiment of the present invention contemplated the inclusion of one or more interactive wide screen video game quadrants which will allow video game teams to compete with other video games teams both within the same facility or outside of the facility with other video gamers

In another embodiment of the present invention, the CORE computer system is adapted to provide real-time, interactive, customized IP content conferences, lectors, and seminars allowing each party the ability to provide real-time input on the screen and allowing a multitude of divergent input from customers both within the facility and those persons remotely located.

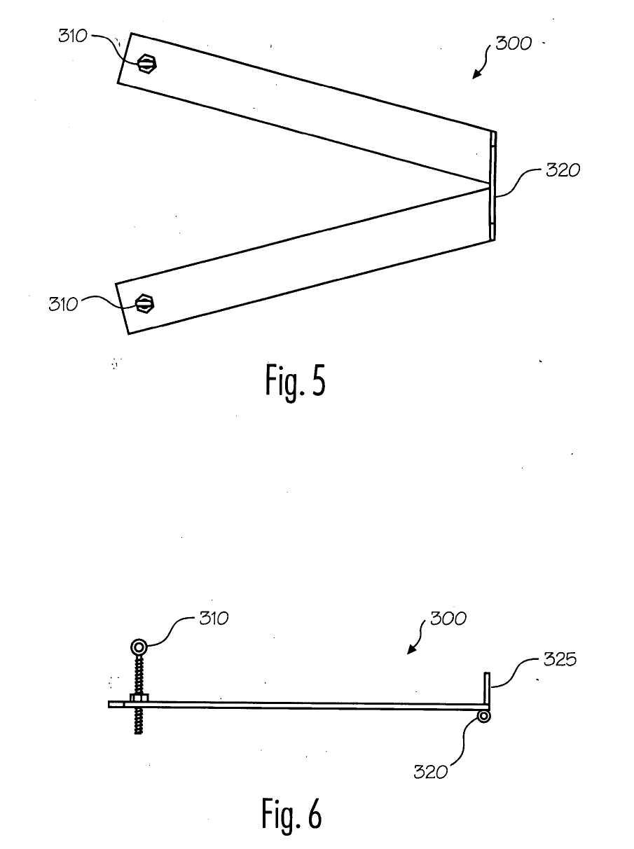

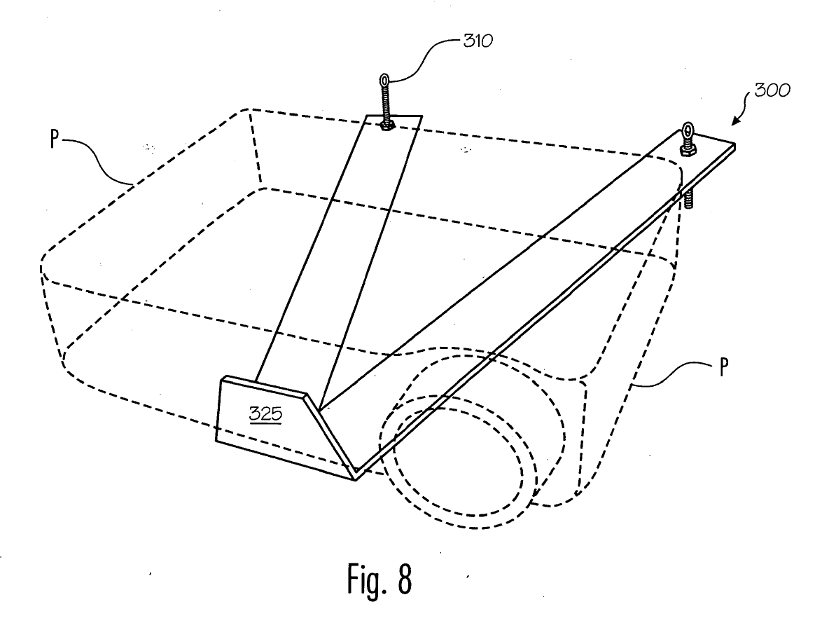

In still another embodiment of the present invention, the CORE computer system electronically communicates with a ceiling-mounted video projector within a screening chamber, and further communicates with a corresponding audio system within the screening chamber. In some applications, the ceiling mounted video projector may be difficult to situate due to either physical constraints within the facility 100, or due to constraints arising from the video projector itself. To overcome this discrepancy, an optional bracket 300 (as seen in FIGS. 5-8) may be employed to mechanically correct the optical path of the video projector P. Bracket 300 is preferably designed to allow the projector P to be mounted on a horizontal surface while allowing the projection angle (and thus, the projector's optical path) to accommodate variously sized and positioned projection screens. In this embodiment, an exemplary bracket 300 is generally formed in a V-shape and containing vertical adjustment means 310 at the end of each leg of the V-shape. In one embodiment, each vertical adjustment means 310 is an adjustment screw mechanism which allows for the vertical repositioning of a projector P when the projector sits upon the bracket 300. Moreover, at the apex 320 of the bracket 300, a lip 325 may be formed thereon to retain the projector P in a secure position and prevent the projector P from falling forward either during adjustment of the vertical adjustment means 310 or during use.

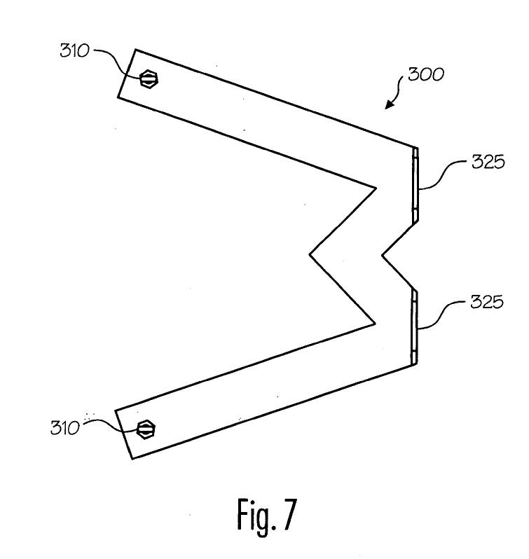

In another embodiment of this invention as seen in FIG. 7, bracket 300 may be generally formed in a W-shape, and containing vertical adjustment means 310 at the end of one or more legs of the W-shape. In this embodiment, bracket 300 accommodates those projectors having an infrared eye in the front, middle portion of the projector, and prevents video signal interference through the use of this bracket. Moreover, bracket 300 in this embodiment may be rotated 180 degrees in order to allow the projector to have an optical path from a lower vantage point when the optical path is directed towards very high projection screens. In this orientation, the adjustment means 310 may be placed in the front of the bracket 300 instead of the back of the bracket 300 as shown in FIG. 7.

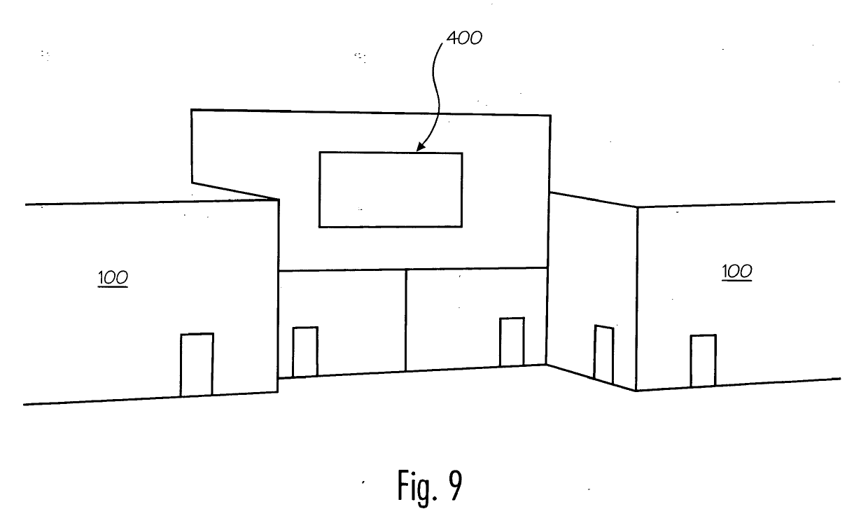

Finally, in another preferred embodiment as seen in FIG. 9, the facility may include a video system 400 which is mounted on the exterior of facility 100 to provide an outdoor video display. Concurrently, an optional exterior sound system (not shown) may be included in this embodiment. Similar to embodiments disclosed above, this embodiment would allow for the video system 400 and corresponding audio system to communicate with the CORE computer system either through wireless technology, wired technology, or any combination thereof.

The present invention may be embodied as a method, system, kit, an apparatus or a device. Other variations and modifications of the present invention will be apparent to those of ordinary skill in the art, and is not limited except by the appended claims. The particular values and configurations discussed above may be varied, and are cited to illustrate particular embodiments of the present invention. It is contemplated that the use of the present invention can involve components having different characteristics as long as the principles disclosed herein are followed.

The disclosed CORE computer system, in still another embodiment, may be configured to manage such clerical operations as order confirmation, printing of receipts, “day” reports, IP content reports, royalty reports based on IP content consumed, IP content inventory reports, and other S business reports. Further business and office management tasks such as new customer rate, current customer activity, cash flow, goal tracking, service error rate, productivity levels, staffing levels, customer trends, legal issues, and external links may be managed or otherwise controlled by the computer system.

An exemplary computer system housing the CORE computer system or the CCORE computer system may comprise at least one server communicating with at least one computer to thereby define an electronic network using any of the commercially available network systems (e.g., land based wirelan network, cable system, wireless networking, Internet, cellular phone, dial-up telephone system, satellite networking, or other network system). A generally commercially available software package may be employed to operate the computer system. The exemplary computer system is configured to be communicatively compatible with most of the current retail and wholesale operating programs and computer operating systems in commercial use while providing a high degree of security from unauthorized access outside of the facility or outside of authorized users of the system, and which allows for layers of security to be applied depending upon the sensitivity of the data involved. The computer system may also be configured with a database for storage and retention of transactional data to allow maximum data storage and ease of access to stored data. A search engine having an IP content database on the computer system may be included that allows maximum flexibility in accessing stored data. In this regard, through the computer controlled system, a user may view and consume any type of IP content, even IP content which was previously recorded (such as, for example, current or past Super Bowl games, golfing events, World Series games, NBA games, award shows, live concerts and pay-for-view events).

In another embodiment, the CORE computer system is adapted to invoice each customer an appropriate amount for each customer consumption of IP content within the facility. The CORE computer system is preferably adapted to receive electronic payments from each customer, and may be adapted to process or order gift cards, coupons, and credit options as well. The CORE computer system is also adapted to transact financial matters in the form of check or case for any on-site financial transactions.

The CORE computer system may also be adapted to store data relating to each customer's choice of IP content, the customer's viewing trends, special dates (such as birthdates), and all other customer-specific information needed for a full retail understanding of each customer. The CORE computer system may also be adapted to retain customer financial data, such as credit card information, debit card information and other payment information so that the customer can select their choice with each subsequent purchase.

In any of the foregoing embodiments, the description of digital data is not dependent upon the format of the stored digitized material, and is equally applicable whether the digitized material is stored using any type of software system, hardware device or any other format.

Additionally, the present invention also contemplates the use of virtual sensory systems, including scents, vibrations, and sprays, in any one of the screening chambers. For example, the CORE computer system could control an olfactory unit in the screening chamber (which contains a combination of scents) to concurrently spray upon command in order to simulate a scene from a movie being consumed in the screening chamber. Similarly, a sprayer (such as a water sprayer) within the screening chamber may be controlled by the CORE computer system to recreate mist, humidity or rain. Similarly, the CORE computer system may control one or more vibration means within the screening chamber to recreate thunder, growls, or very low frequency vibrations.

In addition, another embodiment of the present invention could include the conversion of various existing retail stores to include the IP content screening chambers. As an example, an existing video rental establishment could be converted so that its movie and game inventory could be relocated within the retail store in order include several screening chambers. In this embodiment, a customer could give the retail attendant the movie or game to be viewed and the attendant will allow the customer access to the screening chamber for viewing instead of taking the movie with the customer to be viewed home. In this context, the customer will “consume” the movie within the retail establishment. The advantage to the customer in this embodiment is the state-of-the-art equipment; surround sound, large high definition screen that enhances the viewing quality for the customer. Most customers do not have the financial ability to purchase a media room on their own and through this current invention can utilize the media room to enhance their video game and movie experience.

As will be appreciated by one of ordinary skill in the art, the present invention may be embodied as a method, a process, a data processing system, a firmware system, a hardware system, and/or a computer program product or a combination thereof. Accordingly, the present invention may take the form of an entirely software embodiment, an entirely hardware embodiment, or an embodiment combining aspects of both software and hardware. Additionally, in the foregoing specification, the invention has been described with reference to specific embodiments. However, it will be appreciated that various modifications and changes can be made without departing from the scope of the present invention as set forth in the claims below. The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented in the claims.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “ critical”.

Other variations and modifications of the present invention will be apparent to those of ordinary skill in the art, and it is the intent of the appended claims that such variations and modifications be covered. The particular values and configurations discussed above can be varied, are cited to illustrate representative embodiments of the present invention and are not intended to limit the scope of the invention. It is contemplated that the use of the present invention can involve components having different characteristics as long as the principle is followed.

1-38. (canceled)

39. A method of managing and disbursing intellectual property content offered by an entertainment facility, the method comprising:
receiving, by at least one central computer system of the facility, an order for selected intellectual property content from a user;
processing, by the central computer system, the order for the selected intellectual property content;
disbursing the selected intellectual property content from the central computer system to at least one of a plurality of screening chambers for the user based on the order, wherein each screening chamber comprises an audio/video system located therein; and
transferring, for a time period based on the order, the selected intellectual property content to the at least one screening chamber for the audio/video system.

40. The method of claim 39, further comprising:
storing a plurality of types of intellectual property content in a database of the central computer system;
locating the selected intellectual property content within the plurality of types of intellectual property content; and
retrieving the selected intellectual property content from the stored intellectual property content in the central computer system.

41. The method of claim 39, wherein the processing further comprises determining a time for delivery of the selected intellectual property content from the order.

42. The method of claim 39, further comprising:
enabling, with a switch, the transfer of the selected intellectual property content a beginning of the time period; and
disabling the transfer of the selected intellectual property content an end of the time period.

43. The method of claim 42, wherein the audio/video system is a video game system, the at least one screening chamber is video gaming room of the user.

44. The method of claim 40, further comprising:
retrieving the selected intellectual property from a remote computer system in electronic communication with the central computer system within the entertainment facility, wherein the remote computer system is located outside of the entertainment facility.

45. The method of claim 44, wherein a remote computer system is in electronic communication with a remote video game system.

46. The method of claim 39, wherein the order is placed on a kiosk in the facility in electronic communication with the central computer system.

47. The method of claim 39, the method further comprising:
monitoring, by the central computer system, the screening chamber for a command;
receiving, by the central computer system, the command from a monitor system in electronic communication with the central computer system;
processing the command so in accordance with an action within the command.

48. The method of claim 47, wherein the command comprises at least one of a command to pause the video system, play the video system, stop the video system, and deliver food to the screening chamber.

49. The method of claim 39, further comprising:
controlling, by the central computer system, at least one wall structure of a screening chamber, wherein the central computer system is in electromechanical communication with wall structure; and
adjusting the location of the at least one wall structure based on a change in required seating capacity of the screening chamber.

50. The method of claim 39, wherein the screening chamber further comprises at least one video projector mounted on a ceiling of the at least one screening chamber, wherein the video projector is in electronic communication with the central computer, the method further comprising:
controlling, by the central computer, the video projector; and
adjusting the video projector to change the angle of the video projector with respect to the ceiling.

52. The method of claim 39, wherein, for the receiving step, the central computer system comprising:
a computer processor; and
a server in electronic communication with the computer processor.

53. A method of managing and disbursing intellectual property content offered by an entertainment facility, the method comprising:
receiving, by at least one central computer system of the facility, an order for selected intellectual property content;
processing, by the central computer system, the order for the selected intellectual property content;
storing verification data for at least one consumer of the intellectual property, the verification data comprising consumer identification data and consumer financial data.
disbursing the selected intellectual property content from the central computer system to at least one of a plurality of screening chambers, wherein each screening chamber comprises one or more wall structures, and an audio/video system;
transferring, for a time period based on the order, the selected intellectual property content to the at least one screening chamber for the audio/video system

54. The method of claim 53, further comprising:
receiving, by the central computer system, consumer data comprising consumer account information;
comparing the consumer account information to the stored verification data;
accepting, by the central computer system, electronic payment.

55. The method of claim 53, further comprising:
storing a plurality of types of intellectual property content in a database of the central computer system;
locating the selected intellectual property content within the plurality of types of intellectual property content; and
retrieving the selected intellectual property content from the stored intellectual property content in the central computer system.

56. The method of claim 55, further comprising:
retrieving the selected intellectual property from a remote computer system in electronic communication with the central computer system, wherein the remote computer system is located outside of the entertainment facility.

57. A method of managing and disbursing intellectual property content offered by an entertainment facility, the method comprising:
receiving, by at least one central computer system of the facility, an order for selected intellectual property content;
processing, by the central computer system of the facility, the order for the selected intellectual property content;
storing, by the central computer system, consumer data comprising past purchases of intellectual property content and preferred intellectual property content.
disbursing the selected intellectual property content from the central computer system to a screening chamber, wherein the screening chamber comprises one or more wall structures, an audio system, and a video system;
transmitting, by the screening chamber, the selected intellectual property content.

58. The method of claim 57, further comprising:
storing a plurality of types of intellectual property content in a database of the central computer system;
locating the selected intellectual property content within the plurality of types of intellectual property content; and
retrieving the selected intellectual property content from the stored intellectual property content in the central computer system.

59. The method of claim 58, further comprising:
retrieving the selected intellectual property from a remote computer system in electronic communication with the central computer system, wherein the remote computer system is located outside of the entertainment facility.
